(19) United States
(12) Patent Application Publication
(10) Pub. No.: US 2002/0016835 A1
(43) Pub. Date: Feb. 7, 2002

(54) System and method for cascaded distribution of processing

(76) Inventor: Gary Gamerman, Vienna, VA (US)

Correspondence Address: PILLSBURY WINTHROP LLP, 1600 TYSONS BOULEVARD, MCLEAN, VA, 22102, US

(21) Appl. No.: 09/863,821

(22) Filed: May 24, 2001

Related U.S. Application Data
(60) Provisional application No. 60/206,978, filed on May 25, 2000.

(51) Int. Cl. G06F 15/173; G06F 15/16

(52) U.S. Cl. 709/223; 709/201

(57) ABSTRACT

Systems and methods are provided for distributing processing in a cascaded manner. These systems and methods are capable of providing a distributed network of processors that can provide solutions to respective segments and/or subsegments of a problem posed by one of the processors. Also provided are systems and methods for compensating participants for participating in a distributed computing transaction, and for auctioning, bidding or shopping for rights to engage in such distributed processing tasks. The system and method can be implemented using a software application that can be executed by each of a plurality of processors. The plurality of processors are interconnected by one or more networks. The network connections can be achieved using any of the many well-known mechanisms and protocols, including wireless communications and/or “wired” communications. The system and method are “cascaded” in that at least some of the processors distribute a problem to be solved, or parts thereof, to other processors via at least one intermediate tier of processors. Solutions to segments and/or to subsegments of the problem posed by one of the processors can be solved (e.g., calculated or otherwise suitably developed) by processors in the same tier and/or in different tiers.

### BACKGROUND OF THE INVENTION

The present invention relates to systems and methods for distributing processing in a cascaded manner, and more specifically, to a system and method capable of providing a distributed network of processors that can provide solutions to respective segments and/or subsegments of a problem posed by one of the processors. The present invention also relates to systems and methods for compensating participants for participating in a distributed computing transaction, and for auctioning, bidding or shopping for rights or offers to engage in such distributed processing tasks.

The term “problem” as used herein refers generally to a given type of computation, task, routine, or other processing that can be performed by a computer and that takes input data and processes such data. The term “solution” refers to the results, whether numerical or otherwise, of such computations, tasks, routines, or other processing.

While a single computer can be provided with sufficient resources to adequately provide solutions to various problems, it has been recognized, in a multi-user environment, that significant efficiencies and enhanced communications can be realized by networking a plurality of individual computers. One of the most common networking arrangements is the client/server model. Most business applications today use this model. The Internet's primary program, TCP/IP, also uses this model. In the usual client/server arrangement, one server (or daemon) is activated and awaits client requests. Typically, multiple client programs share the services of a common server program. Both client programs and server programs are often part of a larger program or application. Relative to the Internet, for example, a web browser is a client program that requests services (the sending of web pages or files) from a web server (or Hypertext Transport Protocol server) in another computer on the Internet. Similarly, a TCP/IP program installed in a computer allows the user of the computer to make client requests for files from File Transfer Protocol (FTP) servers in other computers on the Internet. Thus, the concept of exchanging information between networked computers is well known.

The concept of providing distributed processing also is generally known. One example of such distributed processing is the “distributed component object model” (DCOM). DCOM was developed by Microsoft Corporation to enable software components to communicate directly over a network. According to the DCOM protocol, client program objects can request services from server program objects on other computers in a network. DCOM is based on the component object model (COM) (which, in turn, provides a set of interfaces allowing clients and servers to communicate within the same computer (i.e., when that computer is running WINDOWS 98 or a later version of WINDOWS)). According to the DCOM protocol, a page on a web site can be provided with a script or program that can be processed (before being sent to a requesting user) not by the web site server itself, but rather by another, more specialized server object. The specialized server object provides the requisite processing and returns a result to the web site server. This result then is passed to the web page viewer. In addition to the Internet environment, DCOM can be used in a network within an enterprise or other networks. The DCOM protocol uses the well-known TCP/IP and HTTP protocols.

Another example of a known distributed processing protocol is the Common Object Request Broker Architecture (CORBA). The CORBA protocol was sponsored by the Object Management Group, which includes members of the information technology industry, other than Microsoft. The CORBA protocol represents an alternative to the Microsoft-developed DCOM protocol.

DCOM and CORBA applications, however, tend to be single-tiered, such as the SETI@home, Beowulf and other client rest-time or hive applications. In a single-tiered arrangement, when a problem is sent from a first server to another server where it is to be solved (or otherwise processed), the second server typically cannot divide that problem into multiple segments and redistribute those segments to respective additional servers that are adapted to solve (or otherwise process) the respective segments. The typical single-tiered arrangement, in this regard, is not capable of providing a cascaded (or multi-tiered) distribution of objects or other problems or tasks to be processed. Nor are these single-tiered arrangements capable of subdividing segments of the problem into subsegments and distributing the subsegments to still other servers in the network.

The DCOM and similar protocols also suffer from additional problems or limitations. DCOMs typically are unable to attract a sufficient number of members on a regular basis to handle a stream of problems from multiple sources. Typically, DCOMs also are unable to dynamically scale-up the network to compensate for particularly difficult problems, network loading (e.g., the number of solutions and competing resource demands), and/or the overall availability of resources. Another problem with the existing DCOM and similar protocols is the absence of a suitable method or means for efficiently compensating clients in the network for contributing processing resources to the network. Without such compensation, clients are not motivated to contribute processing resources to the network. The efficiency, speed, and overall effectiveness of the network are hampered by this lack of motivation.

There is consequently a need in the art for a system and method capable of distributing processing in a cascaded manner, and more specifically, to a system and method capable of achieving a distributed network of processors that can provide solutions to respective segments and/or subsegments of a problem posed by one of the processors.

While cascaded file searching and file sharing applications are known, such as the recently released GNUTELLA application and revisions thereof, the cascading principals behind such applications have primarily been limited to searching and file sharing functions. The GNUTELLA application provides a massive and informal cascaded network in which each client can act as a file server. Existing GNUTELLA networks have millions of members. In a GNUTELLA network (or Gnet), each member of the Gnet allows the files on one or more of that member's computers to be accessed by other members of the Gnet.

When a Gnet member wants a file (e.g., an MP3 file), that member executes a Gnet search. This search is transmitted to a limited number of other Gnet members (e.g., 10 of my best friends). This limited number of members represents the first tier of members with respect to the member that originally sent the search request. Each member in this first tier of members determines whether it has the requested file. If it does, the requested file or information is transmitted to the requesting member. If it does not have the requested file or information, it automatically forwards the search request to a limited number of additional members that define that particular first tier member's own first tier (i.e., the second tier members with respect to the member that originally sent the search request). Each of these second tier members performs a similar search, and the process repeats for subsequent tiers, until the requested information or file is found (in which case it is transmitted to the requesting party), or until the entire Gnet is exhausted, or until the query expires (if an expiration has been attached). This cascaded system represents a very powerful search engine and file server structure that greatly surpasses the abilities of fixed-point search engines like AOL, LYCOS, YAHOO, and the like. However, inasmuch as the GNUTELLA and similar applications remain primarily directed to the file searching and file sharing functions and have not been adapted to provide a cascaded distribution of processing, there remains a need in the art for a system and method capable of achieving a cascaded distribution of processing.

### SUMMARY OF THE INVENTION

It is a primary object of the present invention to overcome the shortcomings associated with the prior art methods and systems of providing distributed processing by providing a system and method that facilitates distribution of the processing in a cascaded manner.

To achieve this and other objects, the present invention provides a software application that can be executed by each of a plurality of processors. The plurality of processors are interconnected by one or more networks (e.g., a local area network (LAN), a wide area network (WAN), the Internet, and/or the like). The network connections can be achieved using any of the many well-known means and protocols, including wireless communications and/or “wired” communications. The software application, when executed by each of the processors, provides a system for distributing processing among the various processors in a cascaded manner. Provided along with the system is a method for cascadedly distributing the processing among the various processors. The system and method are “cascaded” in that at least some of the processors distribute a problem to be solved, or parts thereof, to other processors via at least one intermediate tier of processors. Solutions to segments and/or to subsegments of the problem posed by one of the processors can be solved (e.g., calculated or otherwise suitably developed) by processors in the same tier and/or in different tiers. The use of a cascade approach allows the resources applied to a problem to rapidly, and exponentially, scale up to the level needed to efficiently solve the query. This approach also enables a system in which the provision of contingent resources to solve query can be commoditized and subjected to retainer and spontaneous transactions (e.g., auctioned, subcontracted, bid and shop). This commoditization of query resources enables the efficient marketing and sale or leasing of excess data processing resources, as well as other transactional structures.

Additional features, objects, and advantages will become readily apparent to those having skill in the art upon viewing the following detailed description, the accompanying drawing, and the appended claims.

### BRIEF DESCRIPTION OF THE DRAWINGS

FIG. 1 is a block diagram showing a system for cascadedly distributing processing, according to a preferred implementation of the present invention.

### DESCRIPTION OF PREFERRED IMPLEMENTATIONS

A preferred embodiment of the present invention will now be described. Although elements of the preferred embodiment are described in terms of a software implementation, the invention may be implemented in software or hardware or firmware, or a combination of two or more of the three. For example, aspects of the invention may be implemented in a computer program product tangibly embodied in a machine-readable storage device for execution by a computer processor. Method steps of the invention may be performed by a computer processor executing a program tangibly embodied on a computer-readable medium to perform functions of the invention by operating on input data and generating output data.

Suitable processors include, by way of example, both general and special purpose microprocessors. Generally, a processor receives instructions and data from a read-only memory and/or a random access memory. Storage devices suitable for tangibly embodying computer program instructions include, for example, all forms of non-volatile memory, such as semiconductor memory devices (e.g., including EPROM, EEPROM, and flash memory devices), magnetic disks (e.g., internal hard disks and removable disks), magneto-optical disks, and optical disks (e.g., CD-ROM disks). Any of the foregoing may be supplemented by, or incorporated into, specially-designed ASICs (application-specific integrated circuits). A computer generally can also receive programs and data from storage medium such as an internal disk or a removable disk. These elements also can be found in the conventional desktop or workstation computer as well as other computers suitable for executing computer programs implementing the methods, described here, which may be used in conjunction with any digital print engine or marking engine, display monitor, or other raster output device capable of producing color or gray scale pixels on a paper, a film, a display screen, or any other output medium.

According to a preferred implementation of the present invention, a software application is provided for execution by each of a plurality of processors. The plurality of processors are interconnected by one or more networks (e.g., a local area network (LAN), a wide area network (WAN), the Internet, and/or the like). The network connections can be achieved using any of the many well-known means and protocols, including wireless communications and/or “wired” communications.

The software application, when executed by each of the processors, provides a system for distributing processing among the various processors in a cascaded manner. Provided along with the system is a method for cascadedly distributing the processing among the various processors. The system and method are “cascaded” in that at least some of the processors distribute a problem to be solved, or parts thereof, to other processors via at least one intermediate tier of processors. Solutions to segments and/or to subsegments of the problem posed by one of the processors can be calculated (or otherwise suitably developed) by processors in the same tier and/or in different tiers. Hereinafter, the term “subsegments” generally refers to segments of a problem segment, or to further divisions thereof, such as sub-subsegments, sub-sub-subsegments, and so forth.

For the sake of nomenclature, any processor that receives a problem, or a part thereof, from the particular processor that originated the problem, will be referred to as a member of the first tier of processors. When any member of the first tier of processors distributes that problem or parts thereof to one or more other processors, those one or more other processors are considered second tier processors with respect to the processor that originated the problem. More downstream tiers (e.g., a third tier, fourth tier, and/or further tiers) can be designated based on the number of intermediate processors between each such downstream tier of processors and the processor that originated the problem.

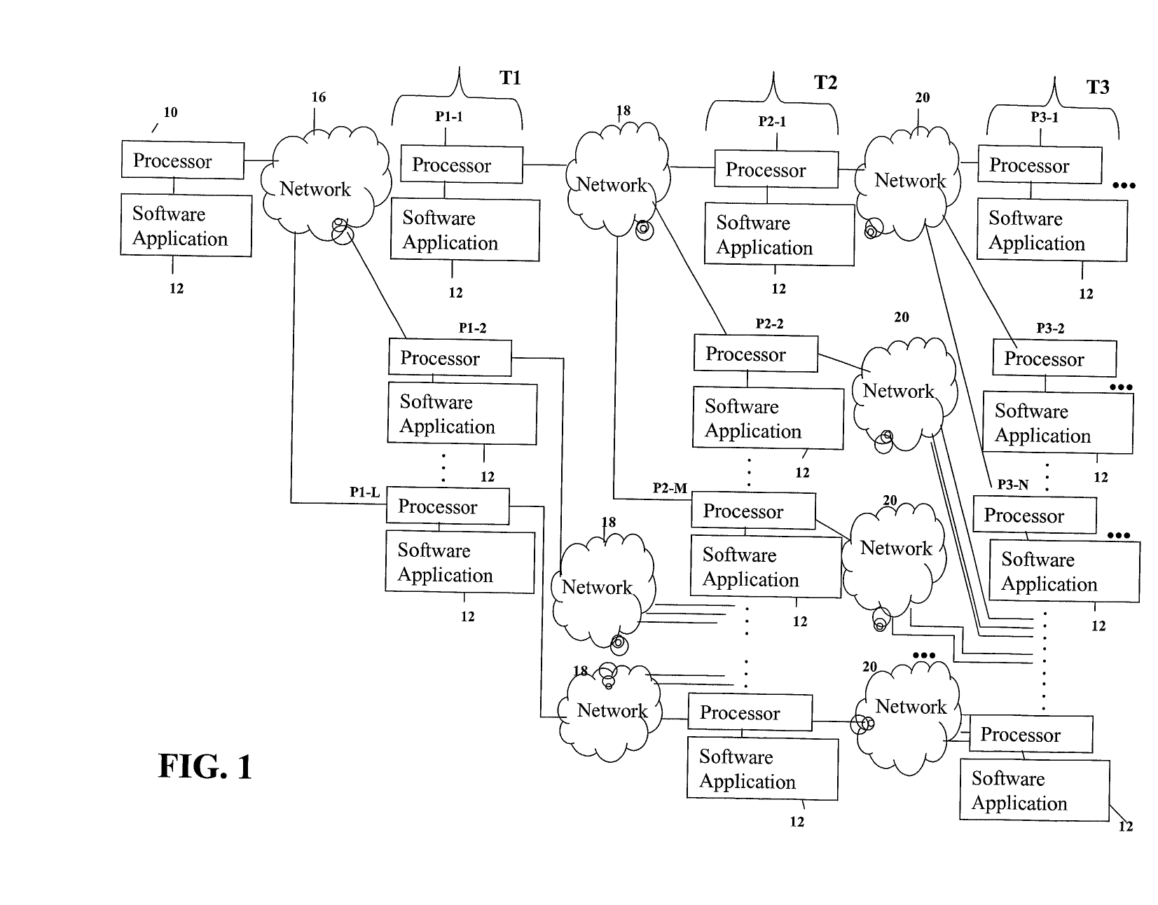

FIG. 1 is a block diagram showing an exemplary processor 10 and a plurality of other processors P1-1, P1-2 . . . P1-L, P2-1, P2-2 . . . P2-M, P3-1, P3-2 . . . P3-N. Each of the processors 10, P1-1, P1-2 . . . P3-N is provided with a version of the software application 12.

With respect to processor 10, FIG. 1 illustrates three tiers T1, T1, and T3 of downstream processors P1-1, P1-2 . . . P3-N. The first tier T1 of processors P1-1, P1-2 . . . P1-L is connected to processor 10 by one or more networks 16. Network(s) 16 can be implemented using any suitable communications network system, such as the Internet, a WAN, a LAN, or the like.

The second tier T2 includes processors P2-1, P2-2 . . . P2-M. One or more networks 18 connect groups of these second tier processors P2-1, P2-2 . . . P2-M to the first tier processors P1-1, P1-2 . . . P1-L. Network(s) 16 and 18 can be different networks, the same network, or combinations of different and the same networks. All or some of the networks 16 and 18, for example, can be defined by the Internet.

The third tier T3 likewise includes processors P3-1, P3-2 . . . P3-N. One or more networks 20 connect groups of these third tier processors P3-1, P3-2 . . . P3-N to the second tier processors P2-1, P2-2 . . . P2-M. Network(s) 16, 18 and/or 20 can be different networks, the same network, or combinations of different and the same networks. All or some of the networks 16, 18 and 20, for example, can be defined by the Internet.

Further downstream tiers (e.g., a fourth tier, fifth tier, and the like) can be provided in a similar manner (i.e., via the same, different, or combinations of networks 16, 18, 20, and/or the like). In FIG. 1, the fourth tier and more downstream tiers have been omitted to keep the drawing from becoming unnecessarily cluttered.

Preferably, the software application is provided in such a way that the first tier is limited to a predetermined number L of processors P1-1, P1-2 . . . P1-L. Desirably, the number L is less than 100. More desirably, the number L is greater than 3 and preferably on the order of about 10. Each first tier processor P1-1, P1-2 . . . P1-L preferably is associated with more than one second tier processor P2-1, P2-2 . . . P2-M. The number (K) of second tier processors P2-1, P2-2 . . . P2-M associated with each one of the first tier processors P1-1, P1-2 . . . P1-L preferably is about the same as the number L of first tier processors P1-1, P1-2 . . . P1-L (i.e., preferably less than 100 and most preferably on the order of about 10). Assuming the exemplary situation where L and K are equal to 10, there are one hundred second tier processors P2-1, P2-2, . . . P2-M (i.e., M=100).

If the software application is further provided in such a way that the number (J) of third tier processors P3-1, P3-2 . . . P3-N associated with each one of the second tier processors P2-1, P2-2 . . . P2-M is equal to 10 (i.e., if J=10), then the total number N of third tier processors P3-1, P3-2 . . . P3-N is one thousand. while the number “J” need not be equal to the number “K”, which in turn, need not be equal to the number L, the above example (where K=J=L=10) clearly demonstrates how each step into using a next downstream tier (e.g., from T1 to T2, from T2 to T3, or the like) in the cascade of processors P1-1, P1-2 . . . P3-N can provide a dramatic increase in the total number (N+J+L) of cascadedly connected processors. Associated with each additional processor P1-1, P1-2 . . . P3-N, there is an incremental increase in total processing resources (quantity, speed, and quality of processing). It should be understood that cascading may take the form of directing query segments (or sub-segments) to processors in a subordinate (or downstream) tier that are better optimized (e.g., in terms of actual performance characteristics or configuration, or available resources) to provide the needed solution, rather than simply to a greater number of processors. Each additional tier in the cascaded system and method of the present invention therefore represents a significant improvement over traditional, single-tiered methods and systems for providing distributed processing.

An exemplary cascaded distribution method will now be described with reference to the exemplary implementation shown in FIG. 1. Initially, the processor 10 poses a problem and transmits at least a portion of this problem to one or more of the processors P1-1, P1-2 . . . P1-L in the first tier T1. Preferably, the problem is divided into segments and the segments of the problem are transmitted to respective ones of the processors P1-1, P1-2 . . . P1-L in the first tier T1. Alternatively, the entire problem can be sent to each or some of the processors P1-1, P1-2 . . . P1-L to provide redundant processing of the problem.

As yet another alternative, the software application can be configured or otherwise present in such a way that it provides some redundancy and some segmentation of the problem's processing. The result is a hybrid of the redundant and segmented distribution techniques. The problem posed by the processor 10, for example, can be divided into fewer than L segments (i.e., into fewer segments than there are processors in the first tier T1, or alternatively or in combination, overlapping segments that can be generated), and these fewer segments of the problem can be transmitted from the processor 10 to respective ones of the fewer processors P1-1, P1-2 . . . P1-H (where H<L) for processing or downstream redistribution by these fewer processors P1-1, P1-2 . . . P1-H. Each of the other processors in the first tier T1 (i.e., each of the processors that did not receive a segment) then can receive the entire problem for processing or downstream redistribution. These other processors in the first tier T1 thus inject some redundancy into the processing of the problem, enabling validity checks and reducing the risk of solution failure due to non-responsive segment receivers (and enabling transactions structures in which members of a tier can compete to deliver the same segment solution), whereas the processors that received segments of the problem provide the advantages of speed and other benefits associated with distributed processing.

Regardless of whether the distribution from the processor 10 to the first tier T1 is a segmented distribution, redundant distribution, or a hybrid thereof, the software application can be provided in such a way that it causes one or more of the processors P1-1, P1-2, . . . P1-L to determine:

1. whether the received segment or entire problem is to be processed entirely by the receiving processor in the first tier T1;

2. whether the received segment or entire problem is to be processed in part by the receiving processor in the first tier T1 and the other part further distributed to one or more of the further downstream processors in tiers T2, T3, and/or the like) for processing or further distribution by such further downstream processors; and/or

3. whether the received segment or entire problem is to be redistributed to one or more of the further downstream processors in tiers T2, T3, and or the like for further processing or further distribution by such further downstream processors.

Similar determinations can be made at each of the processors in the further downstream tiers T2, T3, and/or the like. The foregoing determination(s) can be made based on information transmitted along with the problem from the processor 10, can be made selectively by the owner of each processor 10, P1-1, P1-2 . . . P3-N, and/or can be made automatically by the software application based on predetermined criteria. It should be understood that the determination of redistribution can be structured such that specific processors in the subordinate (or downstream) tier are selected for receiving a particular sub-segment or type of problem from among a much larger number of potential processors that might otherwise comprise that same subordinate tier (e.g. those that have the proper optimization, available resources, cost, reliability).

Examples of the predetermined criteria are the memory resources available to the particular processor, the bandwidth available at the particular processor, the time of day, week, month, or year (e.g., if the owner of the processor has agreed to allocate this processor's resources to cascadedly distributed processing only during certain periods of the day, week, month, year, or the like), the identity of the problem's source (e.g., the identity of the processor 10 that originated the problem or identity of other upstream processors), the processor's speed, the type of software applications, program resources, and hardware resources (e.g., hard disk space, RAM, graphics card, and the like) available locally to the processor (and likewise the known resources available at downstream processors), the type of problem being solved (e.g., whether it is a graphics task, a mathematical calculation, translation of a foreign language, an optical character recognition (OCR) task, or the like), the amount and/or quality of the processor resources dedicated for cascaded distribution of processing by the owner of the particular processor, the “reliability” of the processor (e.g. based on historical results, the probability that the processor will in fact deliver the query solution in conformance with applicable requirements, and the like), the contractual or communication relationships between the dominant and subordinate processors (or the owners of those processors), or combinations of any two or more of these exemplary criteria. If compensation (financial or otherwise) is provided, as will be described hereinafter, for use of processor resources, another exemplary criteria can be the amount or type of such compensation for the particular problem or segment of a problem to be solved. One or more levels of priority, for example, can be developed for higher paying sources of the problems to be processed. The determination of which source is a higher paying source also can take into account the amount of processor resources demanded by the problem, thus providing a measure of efficiency in the priority calculation. Other criteria, of course, could be used as a substitute for, or in addition to, any of the aforementioned exemplary criteria.

Preferably, the software application is provided in such away that any one of the processors 10, P1-1 . . . P3-N and the like can pose a problem to any of the other processors downstream thereof. Processor P1-1 in tier T1, for example, can pose an original problem to one or more of the processors P2-1, P2-2, . . . P2-M in tier T2. With respect to this processor P1-1 in tier T1, the various processors P2-1, P2-2 . . . P2-M in tier T2 represent a first tier, not a second tier. This demonstrates one way in which the order of the tiers T1, T2, T3 is relative to the processor that originally poses the problem.

According to a preferred implementation of the software application, upstream processors for one problem can operate as downstream processors for other problems. The software application, in this regard, can be provided in such a way that, when the downstream processor (e.g., processor P1-1) poses the original problem, the processor 10 that was upstream when it was the original source of the problem, is treated as a downstream processor for purposes of solving or redistributing the problem posed originally by processor P1-1. The processor 10 then can process or cascadedly redistribute the problem provided by the processor P1-1 or a segment thereof to one or more of the other processors P1-2 . . . P1-L in the manner described above. For purposes of a problem posed originally by the processor P1-1, therefore, the other processors P1-2 . . . P1-L in tier T1 can provide second tier processing or redistribution of the problem itself, of segments of that problem, or of subsegments of that problem. Further cascaded redistributions can be achieved in a similar manner. The cascaded distribution thus can proceed upstream in FIG. 1 from any of the various processors in tiers T1, T2, T3 and/or the like.

Preferably, the software application is configured or otherwise provided in such a way that the immediately preceding source of a problem, source of a segment of a problem, or source of a subsegment of a problem, is temporarily blocked from the first tier list of the receiving processor. This advantageously prevents redistribution of a problem, segment, or subsegment back to a processor that has already determined that the problem, segment, or subsegment should be processed elsewhere (i.e., by another processor).

Preferably, each software application includes two modules and is executable by a respective processor. The first module, when executed, causes the respective processor to communicate with other processors that are networked with that processor. The second module, when executed, causes the respective processor to operate sometimes in a query mode and at other times in a solve mode. When contents of a problem received during the solve mode indicate that one or more of the other processors is to provide at least part of a solution to the problem (e.g., based on any of the aforementioned exemplary criteria), the second module causes information about the problem to be transmitted to the other processor(s). There, processing by the other processor(s) occurs, and/or segmenting and redistribution to still additional processors that are networked to the other processor(s).

Preferably, the software application is configured or otherwise provided in such a way that the problem is cascadedly distributed throughout the system (e.g., the system shown in FIG. 1) along with (1) one or more software applications that can be used to solve or redistribute the problem, its segments, or its subsegments, (2) one or more applets that can be used to solve or redistribute the problem, its segments, or its subsegments (e.g., using Java or any other suitable protocol or technique), (3) one or more pointers to a network location or other data storage location where one or more software applications, or where one or more applets, can be obtained for use in solving or redistributing the problem, its segments, or its subsegments, (4) data to be processed when solving the problem, its segments, or its subsegments, (5) one or more pointers to a network location or other data storage location where one or more collections of data reside and from which the data can be accessed when solving the problem, its segments, or its subsegments, and/or (6) one or more pointers to a network location or other data storage location where solutions (i.e., the results of processing) to the problem, its segments, or its subsegments are to be deposited.

The software application of the present invention can be distributed in many different ways, and in this regard, can be distributed to the various processors over the very same network that connects the processors to one another (e.g., the Internet, a WAN, a LAN, combinations of the Internet, LANs, and/or WANs, and/or the like).

The resulting system and method for cascadedly distributed processing provides the advantages of a Gnutella network (e.g., a cascaded structure or interrelationship among members of the system) along with the advantages of existing DCOMs, but without some of the aforementioned significant limitations associated with such DCOMs and Gnutella networks.

Notably, in the above exemplary implementation, the software application can provide two modes of operation, namely, a Query mode and a Solve mode. Other modes of operation also can be provided.

In the Query mode, the processor (or client) posing the query (or posing the problem, problem segment, or problem subsegment) can set the following parameters (and/or allow the software application or an adjunct application to set one or more of the following parameters):

1. The “problem” to be solved;

2. Any specified “division” of the problem into one or more segments that will be posed to each of the first tier Solve Clients (i.e., a processor or other client operating in the Solve mode);

3. The “number and/or identity” of the Solve Clients (i.e., the processors or other clients operating in the Solve mode) that will comprise the first tier, and/or the number and/or identity of any banned Solve Clients at any tier (i.e., processors or other clients that are not to contribute to the problem's solution). The banning of a Solve Client can be selectively performed or performed based on that Solve Client's failure to meet performance requirements or other expectations in response to one or more previous problems.

4. The latency permitted for any segment or subsegment (e.g., the time permitted for return of the solution to each segment or subsegment). This parameter can be left unspecified, for example, if an open ended or auctioning system is used. An auctioning system, for example, is one where the problem, its segments, or subsegments are auctioned off and distributed to downstream processors or Solve clients that provide the most favorable terms (e.g., best price, speed, accuracy, or the like) in exchange for processing of a solution;

5. The compensation to be paid for delivering the solution to the problem, to each segment of the problem, and/or each subsegment of the problem. The compensation parameters can be omitted, for example, if the cascaded processing distribution system is to be implemented in a compensation-free manner; and/or

6. Segment Header Information for each of the segments and/or subsegments of a problem. Segment Header Information can include, for example, a number and/or identity of the Query client (i.e., the processor or client that originated the problem and/or the processor or client that is presenting the segment or subsegment of the problem to the Solve client), segment or subsegment solution criteria (e.g. minimum or maximum accuracy needed, format, estimated resources/time needed to solve the segment or subsegment, the first Solve client tier, solution and subdivision aids, and/or the like), and adjunct logic/information (e.g., security, integrity and authentication mechanisms and information).

The second and/or third of the foregoing exemplary parameters alternatively can be set by a Solve client (i.e., a processor or other client operating in the Solve mode). -With respect to compensation, the software application can be configured or otherwise provided in such a way that compensation is determined on a segment-by-segment basis and/or a subsegment-by-subsegment basis.

In the event that compensation is determined on a segment-by-segment basis, the software application preferably is configured or otherwise provided in such a way that the result of this determination varies as a function of any one or more of the following parameters:

(i) The response time of the Solve client (i.e., of the processor or client that is operating in the Solve mode);

(ii) The quality of the result or solution (e.g., a percent accuracy of the solution returned by a Solve client in response to an OCR problem or query);

(iii)The features of the Solve client (i.e., of the processor or client that is operating in the Solve mode). Examples of such features can include the processor power, whether it is a corporate or private processor, and/or the like; and/or

(iv)The form of compensation (e.g., cash, in-kind return of similar processing service, credits, right to use the majority of a processor's resources, such as in a “free PC”, and/or other forms of consideration) and/or the manner in which the compensation is delivered (e.g., VISA, MASTERCARD, electronic fund transfers, debit transaction, CYBERCASH, and/or the like).

In addition, or alternatively, the determination of compensation can be made on a segment-by-segment basis as a result of bidding or auctioning of the problem via a network-based or other auctioning/bidding mechanism, or by less transient contractual methods (e.g. defined resource retainers, resource requirements supply, available resource provisioning). The segment-by-segment compensation determination, in this regard, can include specifying a maximum price to be paid to the Solve client (or processor) that provides a solution for the lowest cost, within the fastest time, with the best accuracy, and/or the like.

The problem, segment, or subsegment then is transmitted from the processor (or client) that is in the Query mode to the one or more downstream processors in the Solve Mode. This transmission can be achieved, as indicated above, using the appropriate module of the software application and/or network communications features associated with networks 16, 18 and/or 20.

With respect to operation in the Solve mode, one or more of the following parameters can be selectively set (initially or dynamically) by each processor's owner, can be set selectively or automatically as suggested or dictated by information from the next upstream client (or processor) operating in the Query mode, can be set as one or more default settings of the software application, and/or can be selectively or automatically adjusted in a dynamic manner:

i) The resource(s) allocated to solving problems, segments of such problems, and/or subsegments of the problems (i.e., the resources allocated to responding to processors or clients that are in the Query mode). Examples of this parameter include the bandwidth, processor time or use, memory, mass storage, and the like;

ii) Denial or acceptance of certain processors (or clients) so that problems, segments, and/or subsegments posed by those certain processors are not processed, even when those processors operate in the Query mode;

iii) A maximum latency (e.g., a maximum period of time that is tolerated between the initial posing of the related problem, segment, or subsegment and the receipt of a solution thereto) or any other condition that triggers alternative action by the software application.

The software application, in response to such conditions or maximum latencies, can take any one or more actions. Exemplary actions include 1) declining to continue processing of the problem, segment or subsegment, 2) declining to accept the problem, segment or subsegment, 3) dividing a received problem into segments, switching to the Query mode, and passing the resulting segments on to one or more downstream processors (or clients), 4) subdividing a received segment into subsegments, switching to the Query mode, and passing (via subcontracting, auctioning or other transaction) the resulting subsegments on to one or more downstream processors (or clients), or 5) subdividing a received subsegment into further subdivided subsegments, switching to the Query mode, and passing (or further subcontracting) the resulting further subdivided subsegments on to one or more downstream processors (or clients). Notably, these actions can be taken dynamically in response to the initial receipt of a request for processing (i.e., a problem, a segment of the problem, or a subsegment of the problem). These actions also can be take as efforts to obtain a solution progress (e.g., when subdivision and redistribution is performed in response to expiration of the predetermined maximum latency period of time expires before a solution has been obtained). In addition, or alternatively, the foregoing actions can be taken as part of a next-tier bidding, auction, or shopping scheme in which further downstream processors (or clients) receive segments of the problem or subsegments of a segment to be processed.

When any one of the aforementioned exemplary actions 3-5 is taken, the processor (or client) that switches to the Query mode causes the various Query mode parameters to be set. The corresponding problem, segment, or subsegments then is (are) transmitted to the downstream processor(s) (or clients) that are in the Solve mode. This distribution, as indicated above, can be limited in certain circumstances. For example, the process of subdividing segments or subsegments may be restricted and/or controlled by the requirements of the initially posed problem. These restrictions can include the restrictions relating to available subdivision aids, bans on Query clients, security requirements, authentication controls, and/or the like.

The decision logic that determines which of the foregoing actions 1-5 (or other actions) will be taken by each processor (or client) can depend on a range of factors. Exemplary factors include the difficulty associated with obtaining a solution (e.g., the resource requirements, accuracy restrictions, the desired format of the response or solution), the compensation associated with obtaining the solution, the source of the query (e.g., the initial source of the problem, the sources of segments to be processed, or the sources of subsegments to be processed), the resource allocation schemes at that level and downstream thereof. With respect to the last exemplary factor, a business owner of a processor (or client) might accept only night-time processing, whereas “home” users might accept only daytime processing. Other factors can be used, as those with ordinary skill in the art would readily appreciate from the present description.

After each solution is reached, it can be communicated back to the original source of the problem in a number of different ways. According to the preferred implementation of the software application, the solutions can be transmitted back through a return path that follows the original cascaded distribution path through the various processors. In addition, or alternatively, the initial distribution of the problem can include information indicating where solutions are to be transmitted, where the solutions can be stored (e.g., a web-site or the like) for subsequent access by the processor that initially posed the problem, and/or how to notify the processor that originally posed the problem when the solution becomes available.

Such communications of the solution can be achieved using the same or different versions of the networks 16, 18, 20. Preferably, such communications are achieved via the Internet and under the control of a suitably configured version of the software application.

The web-site or other central depository for the various solutions also can be configured to serve as a clearing house for payment management in a compensation-based implementation of the present invention. When a first-tier processor redistributes a segment or subsegment downstream, it can add its own identifier information to the resulting subsegment. The concatenation of Query client host identifiers provides a mechanism for tracing back payment systems, auditing and performing security checks. Such a web-site or other central depository also can be configured to serve as an auction site for segments. Members, in this regard, can post problems (or queries) or pointers to sites with problems or queries. Potential solve clients (or processors operating in the Solve mode) then can sift through the offered problems or queries and select or bid on the desired ones. A bidder also can implement a highly optimized system for solving particular types of problems, such as graphic renderings or data mining, and therefore can sift through the offered problems in search of these types of problems, segments, or subsegments. Management of bidding and related transactional functions can be carried out by suitably modifying existing techniques and principals for consistency with the systems and methods described herein.

The software application also can be paired with additional existing technologies so that the problem, segments, or subsegments are cascadedly distributed and the solutions are returned in such a way that both distribution and return occur via a secure memory and communications space. Encryption can be used in this regard. Likewise, the Solve client (i.e., each processor when it operates in the Solve mode) can be made to provide application integrity checking, authentication signatures (PKI, and the like), communications and data security (VPNS, encryption), and the like.

Additional security can be achieved by implementing redundant use of processors operating in the Solve mode on the same problem, the same segment, or the same subsegments. Cross-checking of the solutions also can be implemented as such solutions arrive at the processors that are operating in the Query mode. Still additional, conventionally known means and techniques can be used to make it very difficult, if not impossible, for the various processors to interfere with the proper functions of the software application (e.g., cause it to give deviant results) or gain unauthorized access to a problem or solution.

The exemplary software application, when implemented as described above, to provide a system and method for cascadedly distributing processing, provides a convenient and practical way to tackle large numbers of very difficult problems. Notably, these very difficult problems can originate from a broad range of sources. Also provided is the ability to bid on problem solving projects.

While the present invention, as indicated above, can be implemented to solve many different types of problems, an exemplary implementation for purposes of solving an optical character recognition (OCR) problem will now be described.

The exemplary problem relates to converting a massive library of scanned paper documents (e.g., 10 million pages in an FDA product application image file) into digital text via OCR conversion. Doing this using a single computer would require massive amounts of computing power and much time. Even fairly modern personal computers using a PENTIUM III processor operating at 600 MHz cannot convert much more than 5-10 pages/minute using OCR techniques from good quality originals. The rate is even slower if the original documents exhibit poor image quality. A single computer thus can be expected to take 1 million minutes to complete the OCR conversion (on the order of about 2 years). A reduction in conversion time to one day would require the computing power of about 800 such computers.

The present invention provides a very favorable alternative to the significant delay of years, and notably, this alternative avoids the need to spend the massive amounts of money typically associated with acquiring 800 such computers.

Using a system implemented according to the present invention, the person needing the conversion can provide his or her processor with access to the software program and cause that processor to enter the Query mode. The exemplary parameters that can be set and exemplary actions that can be taken as a result of entering the Query mode are:

1. An indication that the problem to be solved is a conversion of segments of image data into text using OCR techniques is set as a parameter.

2. The image files are divided into segments of 1,000,000 pages each and some redundancies are added to facilitate subsequent validity checks.

3. Ten first-tier processors are selected to serve as Solve clients.

4. A latency restriction is set to one day.

5. Compensation is set to $1 for each segment that is delivered within the latency restriction and that meets all other criteria (e.g., OCR accuracy and the like). Alternatively, the compensation could be determined, as indicated above, based on bidding/auctioning by the first tier of processors. The bidding/auction format can be open bid, Dutch auction, closed bid, or first delivery (i.e., where the same segments are sent to the first tier and the one that first delivers the solution, on a segment-by-segment basis or in total, gets paid).

6. An indication can be provided that the payment(s) will occur by wire transfer upon acceptance of conforming solutions.

7. The segment header can be provided with pertinent information, including a RUNTIME version of OCR software (e.g., a small binary, Java, or ActiveX applet) to be executed by the Solve processors (or clients). Since the only process to be executed in this example is the conversion, and not viewing, printing, user or application interfacing, the runtime can be made very small and fast.

When the selected Solve processors (or clients) receive their respective segments of the problem (or query), they enter the Solve mode. In the Solve mode, each Solve processor (or client) estimates the latency that it will contribute if it processes the received segment. This estimate is based on the resources of that processor that have been allocated to this problem (e.g., as described hereinafter). Once the estimate is calculated, the Solve processor (or client) determines whether the estimated latency is too close (e.g., reaches or exceeds 20 hours) to the maximum latency (e.g., 24 hours) or exceeds the maximum latency established by the Query processor (or client). If the estimated latency exceeds or is too close to the maximum latency, the Solve processor (or client) triggers a “subdivide” event. Otherwise, it can perform conversion of the segment.

The subdivide event involves subdividing the received 1,000,000-page segment into 100,000-page subsegments, switching to the Query mode, and distributing the subsegments to respective second-tier processors (or clients) that are in the Solve mode. Alternatively, the subdivide event can be partial, whereby some of the second-tier processors (or clients) receive complete segments, while others receive subsegments (some of which can be overlapping).

For illustrative purposes, it will be assumed in this example that each first-tier processor is associated with 10 second-tier processors (and that consequently there are 100 second-tier processors), and that the subdivision was carried out so that each second-tier processor receives a different 100,000-page subsegment. Each of these second-tier processors then carries out the exemplary process described above with respect to the first-tier processes, and can further subdivide the subsegments and redistribute the further subdivided versions. This overall process can be carried out using as many tiers as necessary to ensure that the desired processing is carried out within the latency period specified by the original problem.

The solutions (converted text) to the problem, segment, and/or subsegments then can be communicated upstream to the processor that originally posed the OCR problem (e.g., via the cascaded distribution path), and/or can be otherwise transmitted or deposited to or for subsequent access by that processor. This demonstrates how the cascaded distribution system and method of the present invention greatly facilitates completion of a heretofore daunting OCR problem.

Some or all of the actions that were carried out and parameters that were set in accordance with the above example can be pre-established automatically by the software application (thus requiring no user intervention). In addition, or alternatively, the owner or operator of each processor (or client) can designate for the Solve mode that some percentage (e.g., 80%) of the idle capacity of his or her processor will be available for all cascadedly distributed processings and that some smaller percentage (e.g., 30%) will be available for each or this particular problem). These designations can be performed dynamically, by the software application or otherwise, so that these designations are modulated depending upon, for example, characteristics of the Query (i.e., characteristics of the problem, segments, and/or subsegments). These Query characteristics can include, for example, difficulty of the problem, segment, or subsegment; the source of the problem, segment, or subsegment (e.g, that source's identity, capabilities, and the like); and/or the compensation scheme.

Other uses of the invention for other resource-intensive tasks will become readily apparent to those skilled in the art, upon reviewing this disclosure, and are understood to be encompassed by aspects of the present invention. Examples of such other uses include complex or large scale graphic or audio rendering, modification, compression or analysis; numeric processing (e.g. engineering, meteorological, hydrodynamic, geophysical, atomic and astrophysical analysis); database querying and data transformation; language translations; program compilation, encryption key generation or recovery or testing; site security penetration testing (e.g. utilizing the members of the cascade to iteratively and robustly test a target processor's resistance to external penetration, or modification or disablement); and/or pattern matching and/or assembly (e.g. DNA or peptide sequence evaluation and assembly, receptor-ligand relationship determination).

The software application, when implemented as described above, to provide a system and method for cascadedly distributing processing, advantageously can be used to compensate people and/or companies for use of under-exploited resources (such as daytime home PCs/night-time business PCs). Individuals and businesses thus could earn money by participating with their current processing system, or even by participating using their older, more outdated systems.

The present invention also provides a heretofore unappreciated way to implement an internet service providing business. The business can enter into relationships with customers, whereby the business is able to offer for sale, lease, or otherwise, certain processing resources allocated by each customer. The customer can be provided with a version of the aforementioned software application, which is installed on the customer machine or otherwise causes the customer's processor to implement the methods and system of the present invention. In exchange, the business can compensate such customers with free or inexpensive internet service, free or inexpensive computers, money, and/or other forms of consideration.

Similar businesses can be established on the basis of providing low cost or free processors (e.g., personal computers) to customers that agree to share the processing resources thereof with the cascadedly distributed processing system and method of the present invention. Such a business then can recoup the costs of providing the processors and then profit by reselling or leasing the processing resources allocated by the customer under agreement.

Still other businesses can be formed or expanded to provide first tier, second tier, third tier, and the like processing using their own processors. Such a business, for example, can establish a network of fast solution and/or subdivision/transport engines, and/or reliable/trustworty, high-powered subcontractors with further processing capabilities. Such a business can bid on work, or take on a contract retainer (e.g. act as an outsourcer for Solve Mode processors, and take responsibility for management, compensation, security, and/or the like). Large internet service providers (ISPs) and hosting services are particularly well-suited for implementation of such a business, as they have substantial internal, highly reliable capacity, which capacity is consumed in highly variant utilization patterns, as well as direct access to the resources of their customers and the ability to enter into commercial relationships with such customers in which they have a right to resell or draw upon under-utilized customer resources.

The present invention, as demonstrated above, provides a convenient way of developing a marketplace for processing of problem segments. This, in turn, greatly facilitates solving of such problem segments and provides a corresponding economic benefit.

It thus can be appreciated that the objects of the present invention have been fully and effectively accomplished. It is to be understood that the foregoing specific implementations have been provided to illustrate the functional principles of the present invention and are not intended to be limiting. To the contrary, the present invention is intended to encompass all modifications, substitutions and alterations within the spirit and scope of the appended claims.

It should be noted that limitations of the appended claims have not been phrased in the “means or step for performing a specified function” permitted by 35 U.S.C. §112, ¶6. This is to clearly point out the intent that the claims are not to be interpreted under §112, ¶6 as being limited solely to the structures, acts and materials disclosed in the present application or the equivalents thereof.

What is claimed is:

1. A software application product that is executable by a first processor, said software application product comprising:
a first module that, when executed by the first processor, causes the first processor to communicate with other processors that are networked with said first processor;
a second module that, when executed by said first processor, causes said first processor to operate sometimes in a query mode and at other times in a solve mode, and when contents of a problem received during the solve mode indicate that one or more of the other processors is to provide at least part of a solution to said problem, causes information about said problem to be transmitted to said one or more of the other processors for processing by said one or more processors or for segmenting and distribution by said one or more processors to still additional processors that are networked to said one or more processors.
